(19) United States
(12) Patent Application Publication
(10) Pub. No.: US 2009/0222678 A1
(43) Pub. Date: Sep. 3, 2009

(54) ACTIVE POWERED DEVICE FOR THE APPLICATION OF POWER OVER ETHERNET

(75) Inventors: James Yu, San Francisco, CA (US); Minh Tran, San Jose, CA (US)

Correspondence Address: LAW OFFICE OF DUANE S. KOBAYASHI, P.O. Box 4160, Leesburg, VA, 20177, US

(73) Assignee: Broadcom Corporation, Irvine, CA (US)

(21) Appl. No.: 12/040,593

(22) Filed: Feb. 29, 2008

(51) Int. Cl. G06F 1/26

(52) U.S. Cl. 713/300

(57) ABSTRACT

An active powered device (PD) for the application of power over Ethernet (PoE). In a fixed power budget environment, it is important for the power sourcing equipment (PSE) to accurately determine a power budget for the various powered ports. An active PD can be designed to gather additional information (e.g., current and input voltage) during PD operation and to forward the additional information to the PSE. The PSE can then use the additional information to adjust operational parameters such as a power budget.

### BACKGROUND

1. Field of the Invention

The present invention relates generally to Power over Ethernet (PoE) and, more particularly, to an active powered device (PD) for the application of PoE.

2. Introduction

The IEEE 802.3af and 802.3at PoE specifications provide a framework for delivery of power from power sourcing equipment (PSE) to a powered device (PD) over Ethernet cabling. In this framework, various PDs can be deployed such as voice over IP (VoIP) phones, wireless LAN access points, network cameras, computing devices, etc.

In the PoE process, a valid device detection is first performed. This detection process identifies whether or not it is connected to a valid device to ensure that power is not applied to non-PoE capable devices. After a valid PD is discovered, the PSE can optionally perform a Layer 1 power classification. For example, in the IEEE 802.3af standard, the classification step identifies a power classification of the PD from the various power classes of 15.4 W, 7.0 W, and 4.0 W. In various PoE implementations, a Layer 2 power classification process can be initiated to reclassify the power class or implement some form of dynamic classification.

After the classification process is complete, the PSE would allocate power to the port. In a typical usage scenario, the PSE has a fixed power budget that can easily be oversubscribed by the connected PDs. Management of such a fixed power budget can therefore dictate that lower priority PDs would not receive a power allocation from the PSE.

In this fixed power budget environment, it is important for the PSE to accurately determine a power budget for the various powered ports. Various factors can impact the power budget for the particular port. For example, physical characteristics such as the resistance of the cable connecting the PSE and the PD can impact the power budget for a port. Additionally, the actual power consumption by the PD can impact the power budget for a port. What is needed therefore is a mechanism that enables a PSE to monitor in an effective manner the provision of power on a port.

### SUMMARY

An active powered device (PD) for the application of PoE, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a PoE system.

FIGS. 2A and 2B illustrate a circuit model for the powering of a PD.

FIG. 3 illustrates an embodiment of a mechanism that enables measurement of a cable resistance.

FIG. 4 illustrates an embodiment of a cable resistance detection in a PoE process.

FIG. 5 illustrates a flowchart of a PoE process that uses an active PD.

FIG. 6 illustrates an example environment that benefits from an active PD.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

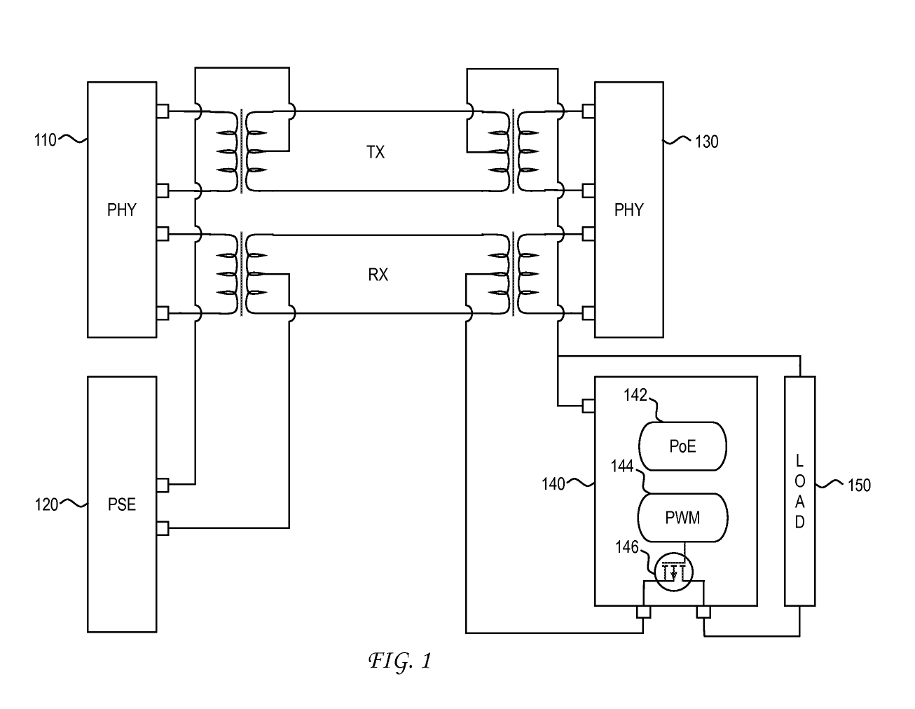

FIG. 1 illustrates an embodiment of a power over Ethernet (PoE) system. As illustrated, the PoE system includes power sourcing equipment (PSE) 120 that transmits power to powered device (PD) 140. Power delivered by the PSE to the PD is provided through the application of a voltage across the center taps of transformers that are coupled to a transmit (TX) pair and a receive (RX) pair of wires carried within an Ethernet cable. In general, the TX/RX pairs can be found in, but not limited to structured cabling. As would be appreciated, various TX/RX pairs can enable data communication between two Ethernet PHYs in accordance with 10BASE-T, 100BASE-TX, 1000BASE-T, 10GBASE-T and/or any other Layer 2 PHY technology.

As is further illustrated in FIG. 1, PD 140 includes PoE module 142. PoE module 142 includes the electronics that would enable PD 140 to communicate with PSE 120 in accordance with a PoE standard such as IEEE 802.3af, 802.3at, legacy PoE transmission, or any other type of PoE transmission. PD 140 also includes pulse width modulation (PWM) DC:DC controller 144 that controls power FET 146, which in turn provides constant power to load 150.

In the example of IEEE 802.3af, PSE 120 can deliver up to 15.4 W of power to a plurality of PDs (only one PD is shown in FIG. 1 for simplicity). In IEEE 802.at, on the other hand, a PSE can deliver up to 30 W of power to a PD over 2-pairs or 60 W of power to a PD over 4-pairs. Other proprietary solutions can potentially deliver even higher levels of power to a PD. In general, high-power solutions are often limited by the limitations of the cabling.

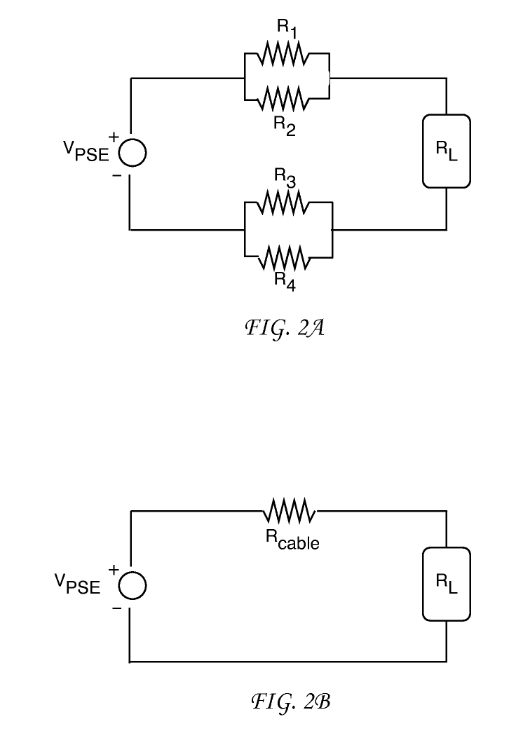

The delivery of power from PSE 120 to load 150 can be modeled by the circuit model illustrated in FIG. 2A. As illustrated, a power source provides a voltage V_{PSE} to a circuit that includes a first parallel pair of resistors (R₁, R₂), a load resistance R_{L}, and a second parallel pair of resistors (R₃, R₄). Here, the first parallel pair of resistors R₁, R₂ represents the resistances of the TX pair of wires, while the second parallel pair of resistors R₃, R₄ represents the resistances of the RX pair of wires.

The values of resistors R₁, R₂, R₃, and R₄ depend on the type and length of Ethernet cable. Specifically, the resistors R₁, R₂, R₃, and R₄ have a certain resistance/length that is dependent on a type of Ethernet cable (e.g., Category 3, 5, 6, etc.). For example, for Category 3 Ethernet cable, resistors R₁, R₂, R₃, and R₄ would have a resistance of approximately 0.2 Ω/meter. Thus, for a 100-meter Category 3 Ethernet cable, each of resistors R₁, R₂, R₃, and R₄ would have a value of 20Ω. In this example, parallel resistors R₁ and R₂ would have an equivalent resistance of 10Ω, while parallel resistors R₃ and R₄ would also have an equivalent resistance of 10Ω. In combination, the total value of the Ethernet cable resistance (R_{cable}) can then be determined as the sum of 10Ω+10Ω=20Ω. A simplified PoE circuit model that includes the single cable resistance value R_{cable} is illustrated in FIG. 2B.

In a typical PoE application, the resistance of the cable is either estimated or assumed to have a worst-case value. For example, an 802.3af PoE application can assume a worst-case resistance of 20Ω, which is the resistance of 100 m of category 3 cable.

In the circuit model of FIG. 2B, where the PD includes a DC:DC converter, the load resistance R_{L} would receive constant power, P_{L}, and see a voltage V_{L} on its input. Since P_{L} is fixed at the load, P_{L}=I*V_{L}, where I is the current going through the whole circuit. The power loss of the cable would then be Pₗₒₛₛ=I²*R_{cable}.

In specifying the minimum output power of 15.4 W for the PSE, the IEEE 802.3af standard assumes that the PD is connected to the PSE using 100 m of Category 3 cable. At a current limit of 350 mA, the worst-case power loss attributed to the cable is Pₗₒₛₛ=(350 mA)²*20Ω=2.45 W. This worst-case power loss of 2.45 W is the difference between the PSE's minimum output power and the max power drawn by the PD (i.e., 15.4 W−12.95 W=2.45 W). As the amount of power loss attributable to the cable is directly proportional to the resistance of the cable, the accuracy of the cable resistance estimate plays a significant role in the accuracy of the power budget.

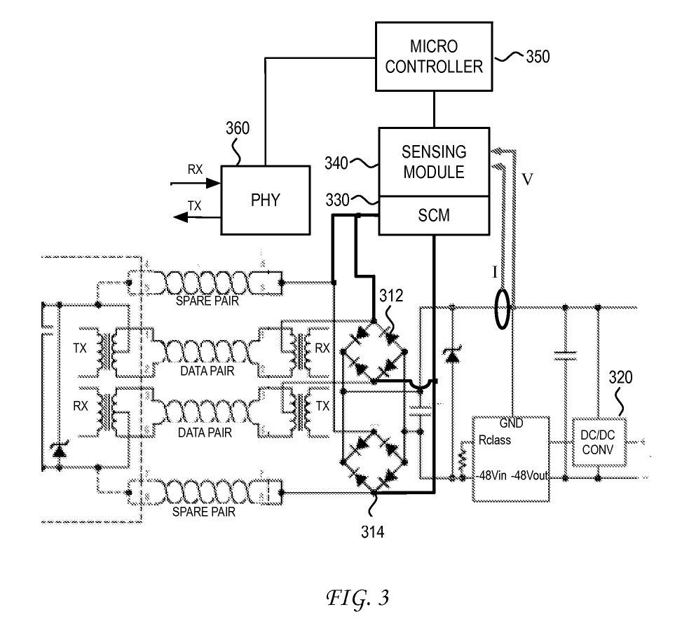

FIG. 3 illustrates an embodiment of a mechanism by which the resistance of the cable can be obtained through a direct measurement. This is in contrast to conventional techniques that are based on cable resistance estimation or worst-case assumptions. As illustrated, the Ethernet cable includes two data wire pairs and two spare wire pairs. The two data wire pairs are used for data transmission (TX) and reception (RX). The PD can receive power that is provided by the data wire pairs and/or the spare wire pairs. Under 802.3af, the two data wire pairs would be used in Alternative A powering, while the two spare wire pairs would be used in Alternative B powering. Power extracted from the two data wire pairs would be routed through diode bridge 312. Power extracted from the two spare wire pairs would be routed through diode bridge 314. DC/DC converter 320 ultimately provides the power to the load in the PD.

The direct measurement of the cable resistance is enabled through the operation of short circuit module (SCM) 330. In general, SCM 330 is designed to produce a short circuit in the PD at a time when the PSE intends to measure the current and voltage of the circuit. As illustrated in FIG. 2B, a short circuit in the PD would remove the load from the overall circuit. The result is a circuit that includes simply the PSE voltage and the cable resistance. With knowledge of both the voltage and the current through the circuit, the PSE can then calculate the resistance of the cable. An embodiment of a SCM is described in co-pending non-provisional patent application Ser. No. 11/849,336, filed Sep. 3, 2007, which is incorporated herein by reference in its entirety.

In the illustration of FIG. 3, SCM 330 is placed in front of diode bridges 312, 314. In this arrangement, SCM 330 can be coupled directly to the two spare wire pairs and/or the taps of the transformers of the two data wire pairs. In another example, SCM 330 is coupled on one end to diode bridges 312, 314, and on the other end to the ground of the PD. SCM 330 can be placed behind diode bridges 312, 314 because the polarity of the voltage received on the two data wire pairs and/or the two spare wire pairs may not be known.

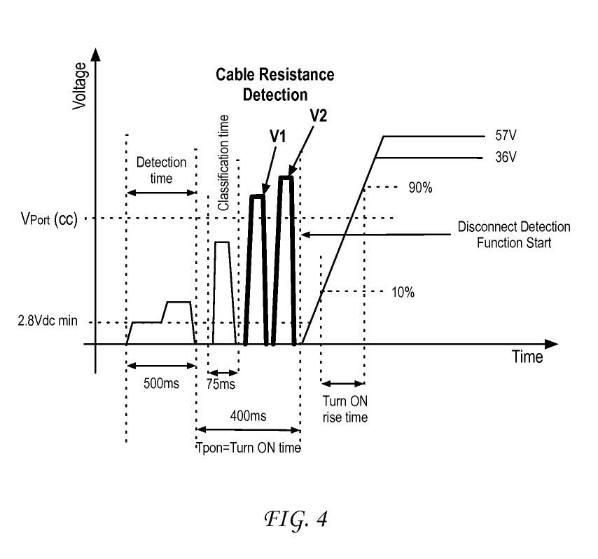

FIG. 4 illustrates one example of a sequence during which SCM 330 produces a short circuit in the PD. In the illustration of FIG. 4, a two-point detection occurs during the 500 ms Detection time. This 500 ms Detection time is followed by a 400 ms Turn On time, the expiration of which would commence powering of the PD. As noted above, an optional classification can also occur after PD detection. This optional classification can occur within the 75 ms Classification time as shown.

In the illustrated example, the cable resistance detection occurs in the time slot between the Classification time and the Turn On time. In another example, the cable resistance detection can be designed to occur in the time slot between the Detection time and the Classification time. As would be appreciated, the particular point in the PoE sequence during which the cable resistance detection would occur would be implementation dependent.

Regardless of the particular point in the PoE sequence during which the cable resistance detection occurs, the direct determination of the cable resistance enables the PSE to accurately establish an initial power budget for a particular PD. This follows since the power loss attributable to the cable would vary significantly depending, for example, on the length of the cable. As the resistance is proportional to the length of the cable, a 100 meter cable would have four times more resistance than a 25 meter cable.

Even with an initial direct determination of the cable resistance, an accurate power budget for a port may still not be possible. This results since the characteristics of the PSE-PD link during operation have not been considered. For example, the cable resistance can change with temperature as the cable heats up during its own operation, or due to the impact of neighboring cables. In another example, the actual power consumption information (e.g., input voltage and current) of the PD may not be known. Typically, a manufacturer would specify a worst-case assumption of power consumption to ensure that the actual operation of the device would not exceed the designed specification. This may lead to an oversubscription of power as requested by the PD.

Conventional PD designs are commonly based on passive designs. This limits the flow of information to the PD. In accordance with the present invention, a PD design is provided that enables the provision of dynamically-gathered information from the PD to the PSE. This information can then be used by the PSE in configuring various elements of PoE system operation. For example, the PD-provided information can be used to alter a power budget attributable to that port.

FIG. 3 illustrates an example embodiment of a PD device that enables the dynamic gathering of information. As illustrated, the PD device includes sensing module 340. In one example, sensing module 340 can be designed to include a current sense device and a voltage sense device that are designed to measure the current (I) and input voltage (V_{L}) dynamically. This current and voltage information can then be provided to microcontroller 350. In turn, microcontroller 350 can forward the dynamically-gathered information back to the PSE through PHY 360 using Layer 2 communication. In various embodiments, one or more of SCM 330, sensing module 340, and microcontroller 350 can be either integrated into a PD chip or shared with other devices (e.g., Ethernet switch).

In this configuration, the active PD device is designed to gather information that is useful by the PSE in monitoring the performance on a particular port. In the current example, the PSE can use the current and voltage information to manage the power dynamically and efficiently. More specifically, the PSE can use the current and voltage to determine the power consumed by the PD load, as well as determine the resistance of the cable.

Across the cable, the voltage drop can be defined as V_{PSE}−V_{L}=I*R_{cable}. This equation can be solved for the cable resistance R_{cable}=(V_{PSE}−V_{L})/I. Since V_{PSE} is known by the PSE, the PSE can then determine the resistance of the cable dynamically using the information provided by the PD. With the determined cable resistance, the PSE can then determine the power loss in the cable as P_{cable}=I²*R_{cable}. This determined result of the power loss in the cable can then be used in combination with the fixed power at the PD (i.e., P_{L}=I*V_{L}) to determine the total power budget attributed to the PSE port.

In general, the principles of the present invention enable a dynamic monitoring process using information that is dynamically gathered by the PD. As would be appreciated, the principles of the present invention are not dependent on a particular type of information that is gathered by the PD. Other types of information such as the status of the PD (e.g., working, idle or sleeping), future power needs, diagnostic information, etc. can be gathered by the PD to aid the PSE in managing power or other operational budgets.

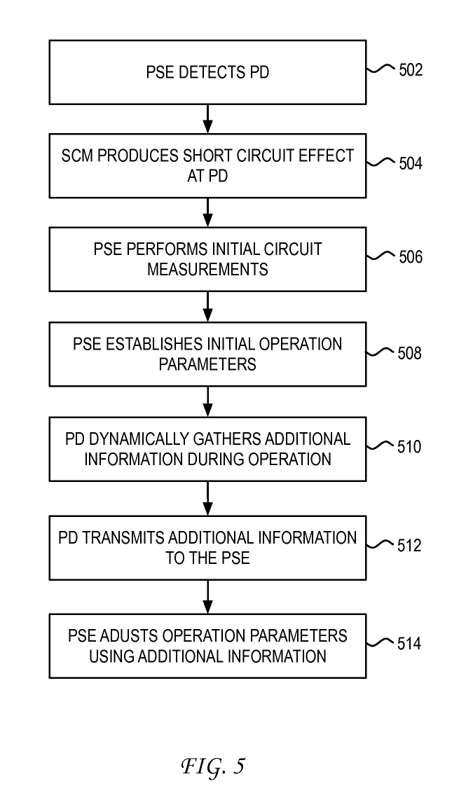

To further illustrate the principles of the present invention, reference is now made to the flowchart of FIG. 5, which illustrates an example PoE process that is designed to manage a PSE port. As illustrated, the process begins at step 502 where the PSE detect the PD. This PD detection can occur during the Detection time illustrated in FIG. 4. Next, at step 504, the SCM in the PD generates a short circuit effect at the PD. This short circuit effect eliminates the load from the circuit and enables the PSE to perform initial circuit measurements at step 506. It should be noted that in one embodiment, a current measurement can also be performed by the PD and communicated to the PSE.

In one example, the initial circuit measurements enable the PSE to determine a cable resistance of the link between the PSE and PD. This cable resistance determination would then enable the PSE to establish initial operation parameters at step 508. For example, the determined cable resistance can be used to establish an initial power budget for the PSE port.

After the turn on voltage has been applied and the PD receives power, the PD can then gather additional information (e.g., current and input voltage) during operation at step 510. As noted, this additional information gathering would be useful to determine whether conditions on the port have changed over time. In one example, the cable resistance may have changed due to a rise in temperature. In another example, the power consumption of the PD may have changed due to a malfunction or other change in operation in the PD. Regardless, the additional information is needed to confirm whether or not the initial operational parameters established at the outset remain true. The active nature of the PD in the present invention is able to facilitate such additional information gathering.

At step 512, the additional information gathered by the PD is transmitted to the PSE at step 512. In one embodiment, this transmission of additional data is facilitated by a microcontroller that leverages Layer 2 communication through a PHY. The receipt of this additional information by the PSE enables the PSE to determine an impact on the PoE system, At step 514, the PSE can determine whether an adjustment of any operation parameters on the port. For example, the current and input voltage can be used to determine if the cable resistance has changed. Any determined change could then impact the power budget for the port.

As has been described, the principles of the present invention enable the PD to provide information that can be useful in establishing and monitoring the operation of a particular port. This increased granularity is key to enabling an increased efficiency in the management of PoE power budgets.

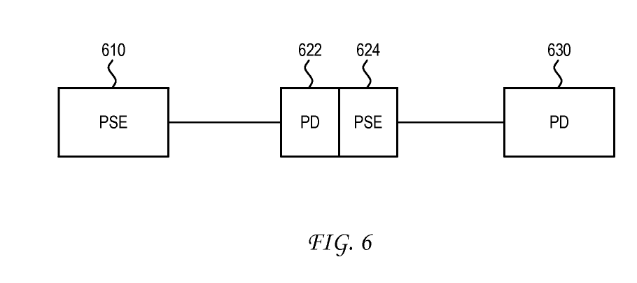

FIG. 6 illustrates an example environment where the principles of the present invention enable increased efficiency. In this example environment, high-power PSE 610 provides power to PD 622, which forwards remaining power to PD 630 using PSE 624. As would be appreciated, further PD/PSE links can be used in a given application. In this example, PSE 610 can represent a PoE-enabled switch, while PSE 624 can represent a local PSE. Local PSE 624 is generally responsible for managing a subset of the power pool that is managed by PSE 610.

In this environment, the power budgets attributable to a single PSE-PD link can have further consequences upstream as the power budgets are dependent upon each other. An accurate understanding of the power budget actually needed for a link is therefore key to ensuring that an overly conservative estimate does not cascade through the PoE network in a manner that produces great inefficiencies. With the principles of the present invention, each PD can be actively involved in the acquisition of information that is useful by a PSE in effecting proper resource management.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A powered device that receives power over Ethernet, comprising:
a powered device signature component that enables a power sourcing equipment to detect a presence of the powered device;
a short circuit module that produces a short circuit effect at the powered device to enable a power sourcing equipment to perform initial circuit measurements of a link connecting the powered device to said power sourcing equipment;
a sensing module that performs additional measurements of the operation of the powered device; and
a controller module that receives said additional measurements from said sensing module and communicates said additional measurements to said power sourcing equipment to monitor the powering of the powered device.

2. The device of claim 1, wherein said initial circuit measurements includes a current measurement.

3. The device of claim 1, wherein said short circuit effect occurs prior to an application of a turn on voltage on said link.

4. The device of claim 1, wherein said additional measurements includes a powered device current measurement.

5. The device of claim 1, wherein said additional measurements includes a powered device voltage measurement.

6. A power over Ethernet method in a powered device, comprising:
activating, at the powered device, a short circuit module that produces a short circuit effect at the powered device to enable a power sourcing equipment to perform initial circuit measurements of a link connecting the powered device to said power sourcing equipment;
activating a module at the powered device that performs additional measurements of the operation of the powered device; and
transmitting said additional measurements to said power sourcing equipment to monitor the powering of the powered device.

7. The method of claim 6, wherein said initial circuit measurements includes a current measurement.

8. The method of claim 6, wherein said short circuit effect occurs prior to an application of a turn on voltage on said link.

9. The method of claim 6, wherein said additional measurements includes a powered device current measurement.

10. The method of claim 6, wherein said additional measurements includes a powered device voltage measurement.

11. A power over Ethernet method for monitoring cable resistance, comprising:
activating, at a powered device, a short circuit module that produces a short circuit effect at the powered device to enable a power sourcing equipment to determine an initial resistance of a cable connecting said powered device to said power sourcing equipment;
measuring a current and voltage at said powered device; and
transmitting, by said powered device, said current and voltage measurements to said power sourcing equipment to enable a calculation of an updated cable resistance.

12. The method of claim 11, wherein said activating comprises activating prior to an application of a turn on voltage by said power sourcing equipment.

13. The method of claim 11, wherein said measuring comprises measuring by a sensing module in said powered device.

14. The method of claim 13, wherein said sensing module forwards said current and voltage measurements to a microcontroller.

15. The method of claim 14, wherein said microcontroller transmits said current and voltage measurements to said power sourcing equipment via Layer 2.
